(19) United States
(12) Patent Application Publication
(10) Pub. No.: US 2012/0056758 A1
(43) Pub. Date: Mar. 8, 2012

(54) VEHICLE PARKING SPOT LOCATOR SYSTEM AND METHOD USING CONNECTED VEHICLES

(75) Inventors: FREDERICK F. KUHLMAN, KOKOMO, IN (US); DWADASI H.R. SARMA, KOKOMO, IN (US); ANDREW P. HARBACK, ARGYLE, TX (US)

(73) Assignee: DELPHI TECHNOLOGIES, INC., TROY, MI (US)

(21) Appl. No.: 13/293,761

(22) Filed: Nov. 10, 2011

Related U.S. Application Data
(63) Continuation-in-part of application No. 12/629,953, filed on Dec. 3, 2009.

(51) Int. Cl. G08G 1/14

(52) U.S. Cl. 340/932.2

(57) ABSTRACT

A vehicle parking spot locator system and method are provided. The system includes a database storing data pertaining to the parking spot locations including available parking spot locations, and a communication link for communicating with a vehicle and other sources. The communication link receives parking spot location information including information pertaining to availability of parking spot locations and further provides vehicles with parking spot location information to assist in locating a parking spot location. The system further includes a processor for processing the stored data in the database and providing parking spot location information to vehicles. The processor is configured to predict which open parking spot is closest to a desired destination and will be available when the vehicle arrives at the desired destination.

### CROSS-REFERENCE TO RELATED APPLICATION

This application is a continuation-in-part of U.S. patent application Ser. No. 12/629,953, filed Dec. 3, 2009, the entire disclosure of which is hereby incorporated herein by reference.

### TECHNICAL FIELD OF INVENTION

The present invention generally relates to vehicle parking assistance, and more particularly relates to a system and method for managing and locating available parking spot locations for one or more vehicles.

### BACKGROUND OF INVENTION

Drivers of automotive vehicles in urban settings frequently waste a lot of time driving around a parking lot in search of an open or optimal parking lot location also referred to as a parking spot. The search for a parking spot can be exasperated when multiple vehicles which are driving in a caravan or together are looking for nearby parking spot locations. To alleviate locating a parking spot, some parking lot facilities have provided an indication in a parking garage that there are parking spaces available. However, the designated parking spot locations are typically not provided to the vehicle driver. Additionally, some parking lot facilities have proposed installing sensors in the parking spots which may allow opening parking spot information to be shared on the

Internet. Satellite radio (e.g., XM Radio®) may also provide information on how full a parking garage is.

Despite the attempts to enhance the parking space locating process, the proposed solutions have several weaknesses. For example, the conventional systems typically depend on the owner or operator of the parking facility to collect the parking lot data and report the data. Additionally, some of the systems require expensive infrastructure changes to install sensors and communication devices, which costs are typically passed on to the users via user fees. The conventional systems typically do not provide assistance in locating the optimal parking spot nor adequately help with multiple vehicle driving scenarios.

### SUMMARY OF THE INVENTION

In accordance with one embodiment, a vehicle parking spot locator system is provided. The system includes a data base, a communication link, and a processor. The database stores data pertaining to vehicle parking spot locations including available parking spot locations. The communication link is for communicating with one or more vehicles. The communication link receives parking spot location information including information pertaining to the availability of one or more parking spot locations. The communication link further provides a vehicle with parking spot location information to assist in locating an available parking spot location. The processor is for processing the stored data in the database and generating parking spot location information relevant to the vehicle. The processor is configured to predict which open parking spot is closest to a desired destination and will be available when the vehicle arrives at the desired destination.

In another embodiment, a method for managing vehicle parking spot locations and providing parking spot location information to one or more vehicles is provided. The method includes the step of storing data in a database pertaining to vehicle parking spot locations including available parking spot locations. The method also includes the step of receiving parking spot location information input via a communication link including information pertaining to availability of parking spot locations. The method also includes the step of processing the stored data in the database with a processor to predict which open parking spot is closest to a desired destination and will be available when a vehicle arrives at the desired destination. The method also includes the step of communicating via the communication link with the vehicle to provide the vehicle with parking spot location information to assist in locating a parking spot location.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic block diagram illustrating a vehicle parking locator system interacting with vehicles and other parking location data sources, according to one embodiment;

FIG. 2 is a schematic view of a vehicle communicating with the parking locator system shown in FIG. 1;

FIG. 3 is a block diagram illustrating the vehicle parking locator system, according to one embodiment;

FIG. 4 is a block diagram illustrating a vehicle and various features utilized in connection with the parking locator system, according to one embodiment;

FIGS. 5A-5C are top views of a parking lot showing a vehicle entering a parking spot in FIG. 5A, parked in the parking spot in FIG. 5B and exiting the parking spot in FIG. 5C, according to one example;

FIGS. 6A-6C are top views of a parking lot illustrating a vehicle entering a parking spot in FIG. 6A, parked in the parking spot in FIG. 6B, and exiting the parking spot in FIG. 6C, according to another example;

FIG. 7 is a flow diagram illustrating a routine for managing and providing parking spot locations, according to one embodiment;

FIG. 8 is a flow diagram illustrating a routine for predicting parking spot availability, according to one embodiment; and

FIG. 9 is a flow diagram illustrating a routine for predicting parking spot availability, according to one embodiment.

### DETAILED DESCRIPTION

In general, a vehicle parking spot locater system and method for providing vehicle parking spot location information is set forth herein that enhances known systems and methods by providing an algorithm to determine which open parking spot is closest to a desired destination and/or to predict which of a plurality of vehicles is most likely to arrive at a particular parking spot first. For a particular vehicle, the algorithm will predict which open parking spot is closest to a desired destination and will be available when the particular vehicle arrives at the desired destination. A vehicle operator may interact with a map of the facility displayed on a global positioning satellite (GPS) device, and indicate a desired destination such as a specific entrance to a mall. The algorithm may calculate a driving time for the vehicle to each open parking spot proximate to the desired destination, and a driving time for any other non-parked vehicle heading for or proximate to the desired destination. Non-parked vehicles include other vehicles that were recently parked and so are assumed to be leaving. The algorithm may then choose a parking spot that is closest to the desired destination, and may consider estimated vehicle driving to select alternate parking spots if other vehicles have smaller estimated driving times. The system may then highlight an optimum driving path to the selected parking spot on the GPS display for example. If a selected parking spot is taken, the algorithm may automatically select a different parking spot. Furthermore, if a better parking spot becomes available, the system may automatically change the selected parking spot. or the parking spot finder system reports the open spot has been taken by someone else.

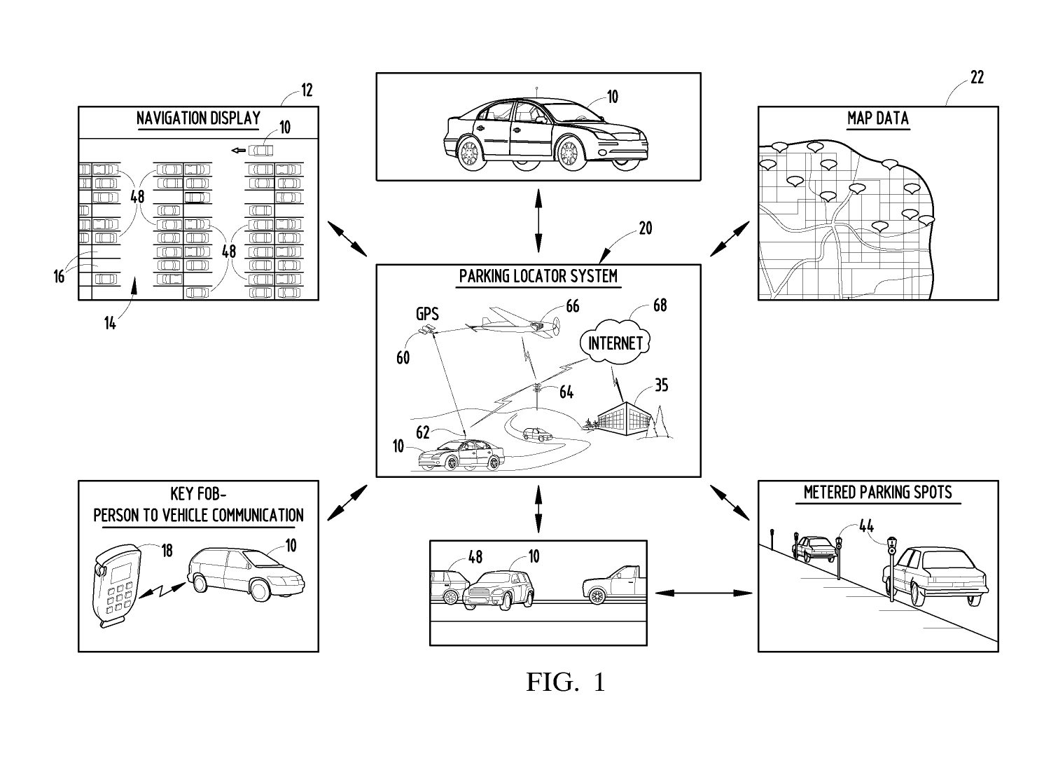

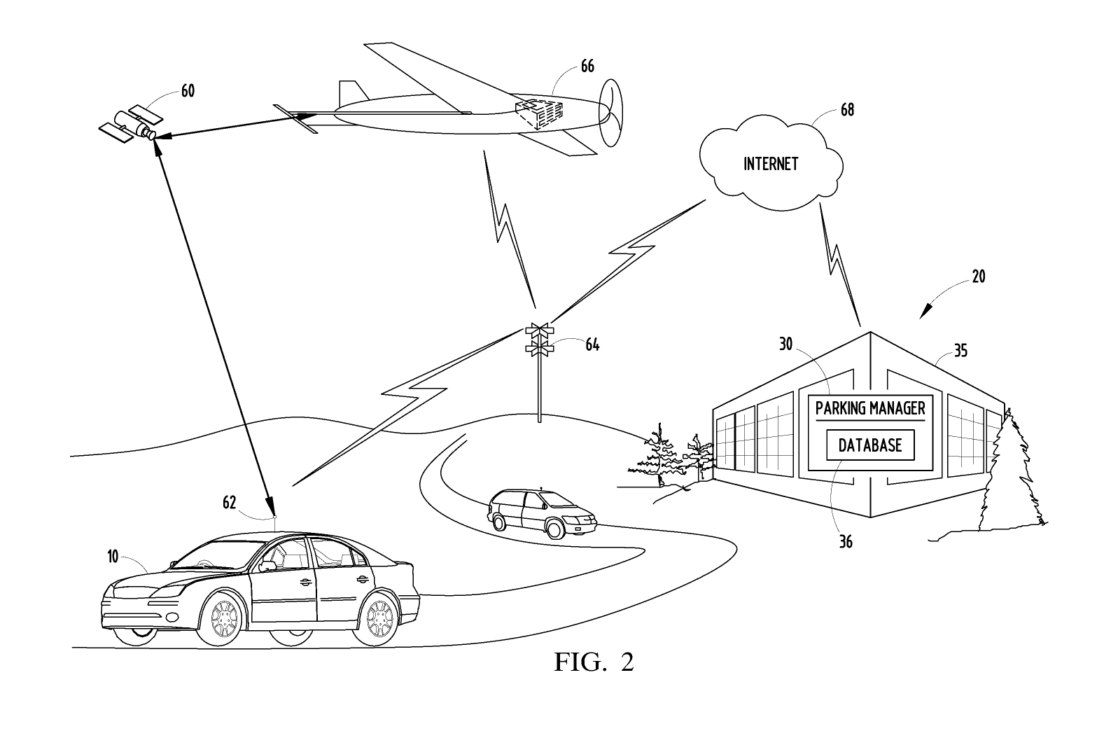

Referring now to FIGS. 1 and 2, a real time vehicle parking spot locator system 20 is generally illustrated in communication with a vehicle 10, and/or other vehicles 48, and devices for assisting vehicles with parking spot locations. The vehicle parking spot locator system 20 includes a database located at a location remote from the vehicles 10, 48, such as a service center 35, according to one embodiment. The database stores data pertaining to vehicle parking spot locations including available parking spot locations.

The vehicle parking spot locator system 20 includes one or more communication links for communicating with the plurality of vehicles 10, 48 and other devices as described herein. The communication link receives from various connected sources parking spot location information including information pertaining to the availability of one or more parking spot locations. The communication link further provides one or more vehicles with parking spot location information to assist one or more vehicles in locating a parking spot location. The vehicle parking spot locator system 20 further includes a processor for processing the stored data in the database and generating parking spot location information relevant to the one or more vehicles 10, 48.

The vehicle parking spot locator system 20 is shown in FIG. 2 having a service center 35 in signal communication with the vehicle 10 that may be interconnected, such as via a communication link that may include an internet connection 68. The service center 35 contains the vehicle parking spot locator system 20 including a parking manager 30 and a real time database 36. The internet access for the vehicle 10 may be achieved by way of wireless communication using a cellular service provider, OnStar®, a mesh network or other peer-to-peer wireless network, or other available wireless communication link. In the embodiment shown, one or more antennas 62 are provided on the vehicle 10 to communicate with terrestrial antennas 64. Alternately or in combination, the communication link may communicate wireless signals with vehicles 10 via satellites 60 and other devices, such as a repeater on aircraft 66 having communication reception and transmission capability. Each vehicle 10, 48 may be equipped with various sensors and devices that generate signals that may be communicated to the database 36 at service center 35 by way of the communication link to provide real time information relating to the position of the vehicle 10, positions of other vehicles 48, and parking lot information. Additionally, other connected sensors and devices located remote from the vehicle 10 may also communicate parking related information to the database. The information communicated to the database 36 may be stored in memory in the database and processed as described herein to provide useful parking lot information for use by the vehicle 10 or the other vehicles 48. The information stored in memory may be updated continually such that it is essentially real time data.

As seen in FIG. 1, the vehicle parking spot locator system 20 communicates with the vehicle 10. The vehicle 10 may employ a navigation display or other display monitor for displaying map and parking lot location information. The display 12 may show a parking lot 14 as shown that includes parking spot locations 16 that are available for parking relative to occupied parking spots and other vehicles 48. Map data 22 may be provided via various sources and used by the vehicle parking spot locator system 20 or pre-installed within each vehicle 10, 48. The map data 22 may include data pertaining to parking lot locations and roadways as should be evident to those skilled in the art.

The vehicle parking spot locator system 20 is shown communicating with a key fob 18 that may remotely control various features of a vehicle 10, such as trunk and door unlock functions. The key fob 18 is a person-to-vehicle communication device operated by a person to control vehicle functions and may further be useful to provide information about the vehicle 10 and the predicted use of the vehicle 10, such as an operator is expected to operate the vehicle 10 and depart from a parking spot location shortly after unlocking the doors. Additionally, remote sources, such as parking meters 44 are shown at metered parking spot locations that are allocated for vehicles to park in. The parking meters 44 may be smart sensors that have sensors that sense whether a vehicle is present in the corresponding parking spot. The parking meters 44 may be connected via signal communication to provide a signal indicative of a vehicle occupying the parking spot location or not based on the expiration of time of the meter, according to one embodiment. According to another embodiment, metered parking spots may be sensed by sensor(s) such as camera(s) located on one or more vehicles that are traveling by to determine parking spot vacancies. For street side parking spots, the street side may be treated as a one-dimensional parking lot. The parking meter information, whether it is sensed vehicle information or based on the time expiration of the meter, may be provided to the database via signal communication for use in the vehicle parking spot locator system 20 as a further connected source for vehicle parking spot location information.

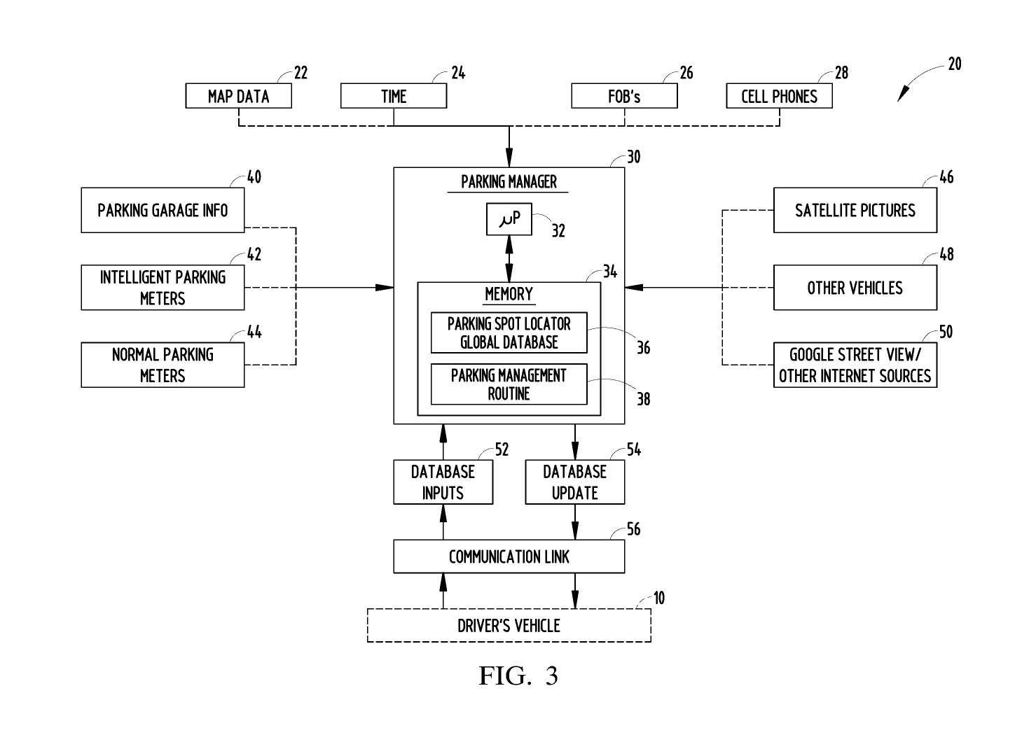

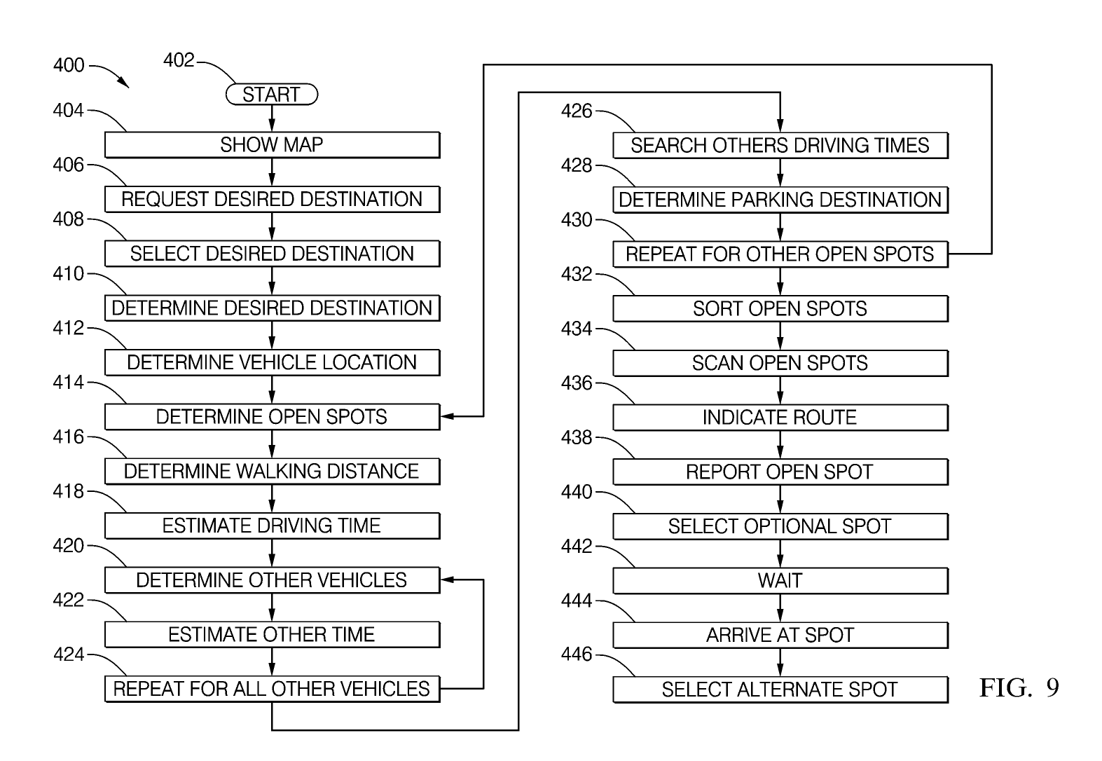

The vehicle parking spot locator system 20 is illustrated in further detail in FIG. 3 having a parking manager 30 configured to receive various input data and provide processed outputs. The parking manager 30 includes a processor 32 such as a microprocessor or other analog and/or digital processing circuitry. The parking manager 30 also includes memory 34, such as random access memory (RAM), read-only memory (ROM), electronically-erasable programmable read-only memory (EEPROM), flash memory, and other memory devices. Stored within memory 34 and processed by the processor 32 is the database 36 for storing vehicle parking spot location information collected from various connected vehicles and other sources and made available for use in providing parking spot location information to one or more vehicles. Additionally, one or more parking management routines 38 are also stored in memory and executable by the processor 32. For example, a routine executed by the processor 32 may enable the processor 32 to predict which open parking spot is closest to a desired destination and will be available when the vehicle 10 arrives at the desired destination. If more than one vehicle is bound for the desired destination, then the vehicle most likely to arrive first may be directed to the closest open parking spot, and the vehicle likely to arrive next may be directed to the next closest parking spot. Furthermore, as the various vehicles approach the desired destination, if new parking spots become available because another vehicle 48 leaves, the routine executed by the processor 32 may update which parking spot each approaching vehicle is directed toward. Additional examples of routines that configure the processor 32 are presented below with regard to FIG. 9.

The parking manager 30 is shown having a communication link 56 that enables the parking manager 30 to communicate with various connected vehicles and other connected sources of information. The communication link 56 may include an internet connection 68 that may be achieved by use of wireless cellular phones and landlines, according to one embodiment. The communication link 56 may include other wireless and satellite signal communications, such as OnStar®. The communication link 56 is in communication with various vehicles including one or more vehicles that provide data to the database 36 and receive parking lot information from the database 36. Parking manager 30 may provide database updates 54 via the communication link 56 to a driver's vehicle 10, such that the driver of the vehicle 10 may use the information to find a desired vehicle parking spot location. Additionally, vehicles 10 may report database inputs 52 via the communication link 56 to the parking manager 30, such as the location of the vehicle and available parking spot locations relative to other vehicles.

The parking manager 30 also receives map data 22, time information 24, key fob information 26, and cell phone information 28 from various inputs. Additionally, the parking manager 30 receives other sources of information, such as parking garage information 40 which may include information relayed from a parking garage facility indicative of the parking garage map, and vacancy of parking lots as reported by the parking garage facility via the internet or other communication link. Intelligent or smart parking meters 42 having sensors for sensing the presence of a vehicle may report via the internet or other communication link vehicle parking information to the parking manager 30. Additionally, parking meters without sensor(s) 44 may report parking lot information to the parking manager 30 such as whether the meter has timed out, thus inferring that the parking spot may be vacant. The parking manager 30 may further receive satellite generated pictures or photos (e.g., Google® Earth) 46 which may include further information regarding availability of parking spot locations. The parking manager 30 is shown communicating with other vehicles 48 which may include information such as position of the vehicles and sensed data which may be useful in determining whether certain parking spot locations are available. Further, the parking manager 30 is shown receiving Google® street view/other internet sources information 50 may provide additional information that may be helpful in determining parking lot location information.

It should be appreciated that the vehicle parking spot locator system 20 is located at a designated service location, such as a service provider, remote from the vehicles, according to one embodiment. The vehicle parking spot locator system 20 may be integrated with other service providers, such as OnStar®, XM/Sirius Radio®, and other service providers that communicate with vehicles to provide an integrated system for parking assist. It should further be appreciated that some or all of the vehicle parking spot locator system 20 may be otherwise integrated into one or more vehicles, such that the memory and processing of vehicles may be employed as part or all of the vehicle parking spot locator system 20, according to other embodiments.

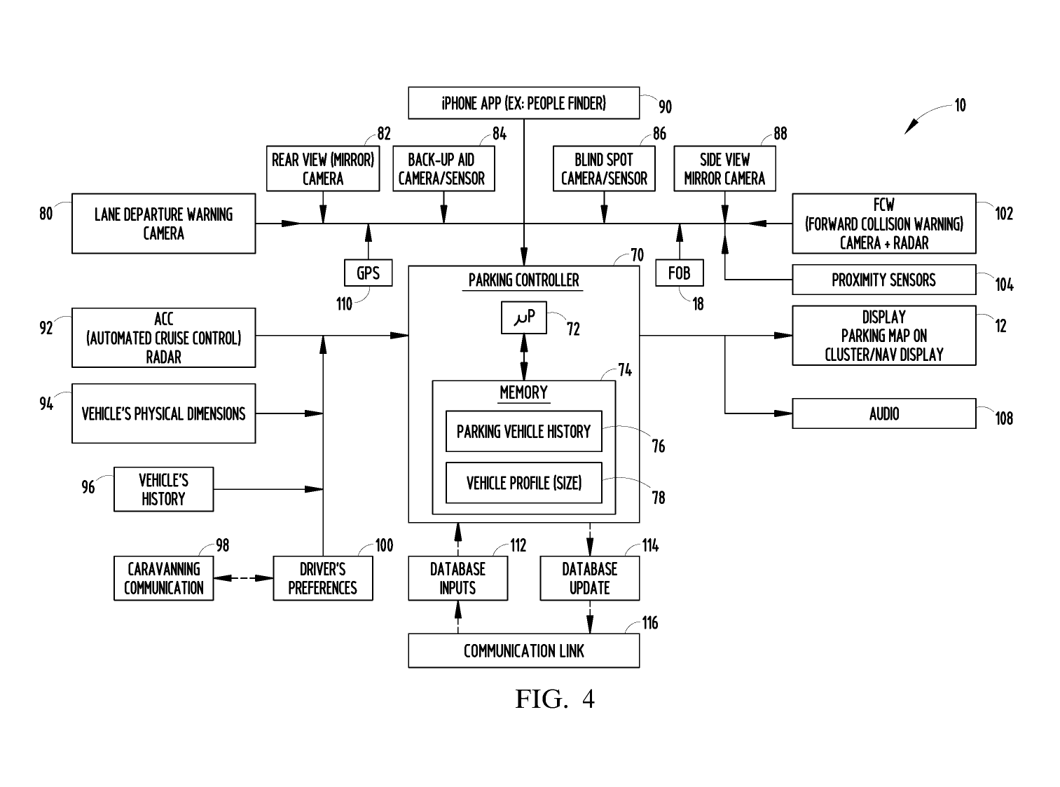

A vehicle 10 configured to communicate with the vehicle parking spot locator system 20 is illustrated in the block diagram in FIG. 4. Vehicle 10 is illustrated having a parking controller 70 shown having various inputs and outputs and communicating database updates 114 and database inputs 112 with the parking spot locator system via a communication link 116. The communication link 116 may include cellular phone, internet connection, satellite communication or other communications or a combination of communication services. The parking controller 70 is shown having a microprocessor 72 and memory 74. Microprocessor 72 may include any digital and/or analog circuitry for controlling the processing of various inputs and providing outputs. Memory 74 may include random access memory (RAM), read-only memory (ROM), electronically-erasable programmable read-only memory (EEPROM), flash memory, and other known memory devices. Stored within memory 74 are parking vehicle history data 76 and vehicle profile data 78, which may be processed by the microprocessor 72. The vehicle parking history data 76 may track historical data that is indicative of what a vehicle is predicted to do based on its history such as when and where the vehicle typically parks. The vehicle profile data 78 may include length and width data of the vehicle and any other profile information that may aid in finding a suitable parking spot for the vehicle. It should be appreciated that the parking controller 70 may be a dedicated controller dedicated to managing vehicle parking information, according to one embodiment. According to another embodiment, the parking controller 70 may be integrated with other vehicle control circuitry, according to other embodiments.

The vehicle 10 is shown having various sensors for sensing one or more conditions of the vehicle 10 and its surrounding area. The various inputs include sensors 80, for example a lane departure warning camera, a rearview camera 82, a backup aid camera/sensor 84, a blind spot camera/sensor 86, a side view minor camera 88, a forward collision warning (FCW) camera and radar 102, an automatic cruise control (ACC) radar 92, and various other proximity sensors 104. The various sensor inputs are provided to the parking controller 70 which may process the inputs and/or send the inputs to the vehicle parking spot locator system 20. The sensor inputs provide information regarding the area proximate to the vehicle 10 such as whether a parking spot location exists proximate to the vehicle 10 and whether another vehicle is parked in the parking spot location or it is unoccupied. The parking controller 70 also receives global positioning system (GPS) signals from a GPS receiver 110 indicating the position of the vehicle 10 and fob signals from the key fob 18. The GPS signals acquires position data which may be transmitted to the vehicle parking spot location system 20. Parking controller 70 may further receive signals from other devices, such as a phone as shown by an iPhone® application 90. The parking controller 70 may include further inputs such as the vehicle's physical dimensions (e.g., width and length) 94, the vehicle's history 96, caravanning communication information 98, and driver's preferences 100. It should be appreciated that the various aforementioned sensors and devices may be installed onboard the vehicle for other vehicle applications such that the vehicle parking spot locator system 20 does not require added sensors and devices to be implemented on a given vehicle.

The vehicle 10 is further shown having a display 12 that may display a parking map on a cluster/navigation display, according to one embodiment. The display 12 may otherwise be displayed elsewhere on the vehicle, such as on a rearview minor or on other displays integrated within the vehicle 10 or in communication therewith. The vehicle 10 further includes an audio output 108. It should be appreciated that the parking controller 70 may output signals to the display 12 and the audio output 108 to direct the driver of the vehicle 10 to one or more available parking spot locations as determined by the vehicle parking spot locator system 20.

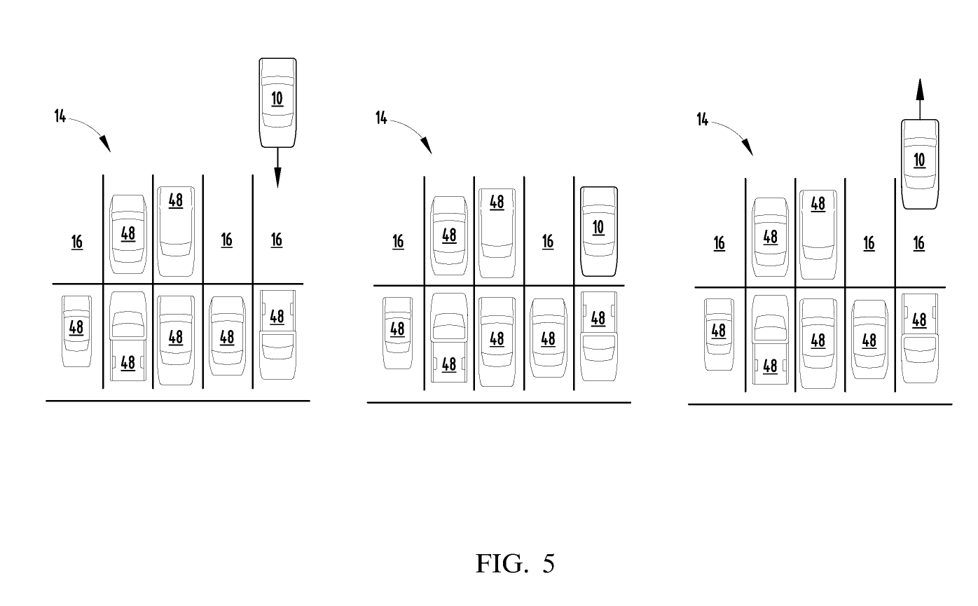

Referring to FIGS. 5A-5C, a vehicle 10 is shown approaching an available parking spot location 16 in a parking lot 14 using the vehicle parking spot locator system 20. The parking lot 14 is shown having a plurality of other vehicles 48 in parking spot locations 16, and having parking spot locations 16 that are unoccupied. It should be appreciated that the vehicle parking spot locator system 20 may provide a map for display showing the availability of the available parking spot location 16 to assist in directing the vehicle 10 into a suitable parking spot location at the driver's discretion. In FIG. 5B, the vehicle 10 is shown parked within one of the available parking spot locations 16. In this position, the GPS position of the vehicle 10 may be reported to the vehicle parking spot locator system 20 such that the vehicle parking spot locator system 20 recognizes that the vehicle 10 is consuming a certain space of one of the parking spot locations 16 in the parking lot 14. In FIG. 5C, the vehicle 10 is shown departing from the parking spot location 16. The vehicle 10 may report its position via GPS signals to the vehicle parking spot locator system 20 such that the vehicle parking spot locator system 20 may use the updated information and identify that the parking spot location 16 is now unoccupied and available.

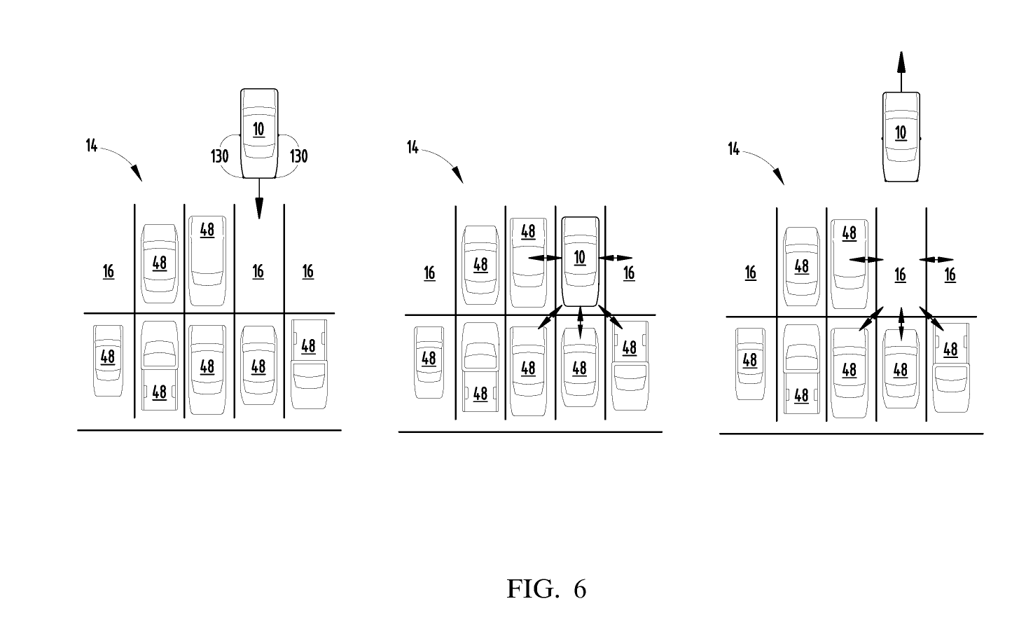

Referring to FIGS. 6A-6C, a parking lot 14 is illustrated with a vehicle 10 approaching an available parking spot location 16, according to another embodiment. In this embodiment, the vehicle 10 employs proximity sensors 130 for sensing the area surrounding the vehicle. The proximity sensors 130 may include proximity sensors such as radar sensors and imaging devices, such as cameras. The proximity sensors 130 detect the regions around the vehicle 10 and report information regarding the detected regions to the vehicle parking spot locator system 20. As shown in FIG. 6B, the vehicle 10 is parked within an available parking spot location 16 and the proximity sensors 130 detect whether the parking spot locations to the lateral sides of the vehicle 10, forward of the vehicle 10, and to the front corners of the vehicle 10 are occupied by other vehicles or not. The vehicle 10 may then report the proximity sensed information to the vehicle parking spot locator system 20 so that it may use that information for determining parking spot location information. In FIG. 6C, the vehicle 10 departs the available parking spot location and may report via its GPS determined position that it is no longer parked within the previously occupied parking spot location.

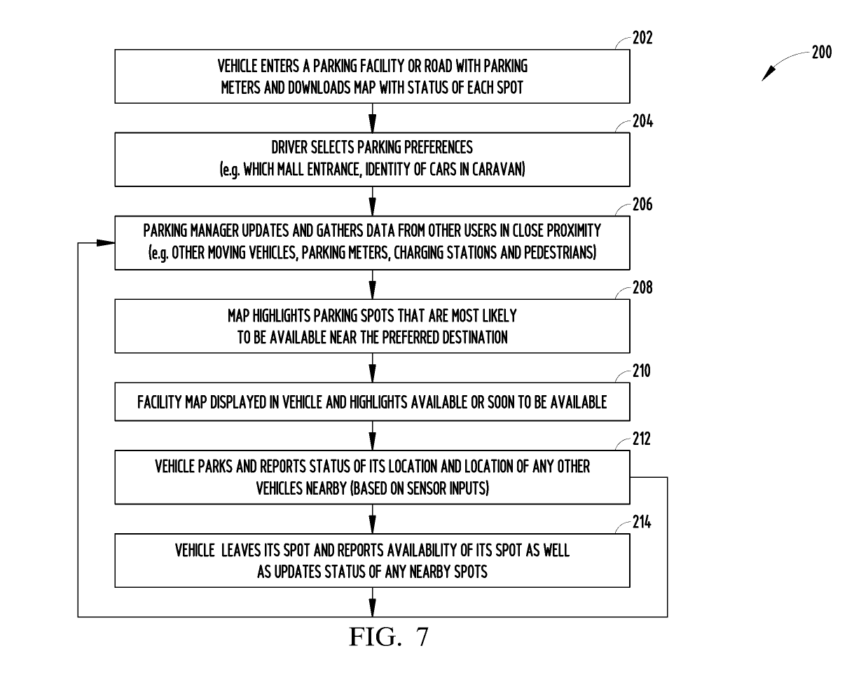

Referring to FIG. 7, a routine 200 is illustrated for acquiring parking spot location information and reporting parking spot location information with the vehicle parking spot locator system 20, according to one embodiment. Routine 200 begins at step 202 in which the vehicle enters a parking facility or road with parking meters and downloads a map with the status of each parking spot location. The map may be downloaded from the vehicle parking spot locator system 20 to a vehicle 10, according to one embodiment. The vehicle 10 may also acquire parking spot location information from the vehicle parking spot locator system 20. Proceeding to step 204, a driver selects parking preferences. For example, a driver may select which entrance of a mall is preferred, or may identify other vehicles traveling together in a caravan, such that all vehicles in the caravan may find suitable nearby parking. Next, in step 206, the parking manager of the vehicle parking spot locator system updates and gathers parking spot location information from other connected sources including users in close proximity to the downloaded map. For example, other moving vehicles, parking meters, electronic vehicle charging stations and pedestrians may provide information to the parking spot locator system that are used to determine the availability of parking spot locations in the desired area. In step 208, routine 200 proceeds to provide a map for display that highlights the parking spots that are most likely to be available near the preferred destination. The map is then presented for display in the vehicle searching for a parking spot and highlights the available or soon to be available parking spot locations at step 210. Next, at step 212, when the vehicle parks within a parking spot location, the vehicle location is reported to the vehicle parking spot locator system along with other vehicle information such as availability of nearby parking spots as detected by the vehicle proximity sensors. When the vehicle leaves the parking spot, the vehicle then reports the availability of its own parking spot as well as updates the status of nearby parking spots in step 214. Accordingly, the vehicle is used as a connected source to provide vehicle parking information to the vehicle parking spot locator system 20 and relies upon information provided by the vehicle parking spot locator system 20 to aid or assist in parking the vehicle.

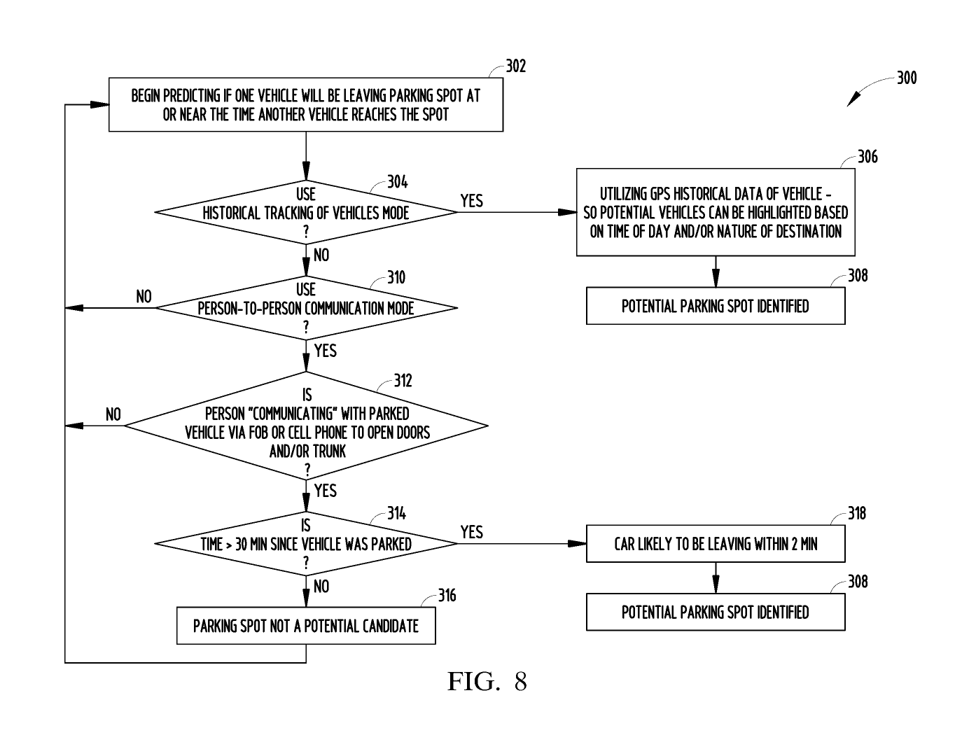

Referring to FIG. 8, a routine 300 is generally illustrated for predicting the availability of future anticipated parking spots with the vehicle parking spot locator system, according to one embodiment. The routine 300 begins at step 302 to begin predicting if one vehicle will be leaving a parking spot at or near the time another vehicle reaches the same parking spot. Routine 300 decides whether to use a historical tracking of vehicles mode at step 304 which may include using the periodic history of the use of the vehicle such as whether the vehicle arrives at work at a certain time, leaves work at a certain time, and has preferred parking spot locations such as near a certain door of a facility. If the historical tracking of vehicles mode is used, routine 300 proceeds to step 306 which utilizes GPS and historical data of the vehicle so that potential vehicles can be highlighted based on time of day and/or nature of the destination. Next, at step 308, potential parking spot locations may be identified based upon the historical data. If routine 300 is not in the historical tracking of vehicles mode, routine 300 proceeds to step 310 to determine whether to use the person-to-vehicle communication mode which may use person-to-vehicle communications, such as key fob signals. If the person-to-vehicle communication mode is used, then routine 300 proceeds to step 312 to determine if a person communicates with a parked vehicle via the key fob or cell phone to open doors and/or trunk, according to one example. If a person communicates via the key fob or cell phone, then routine 300 proceeds to decision step 314, in which routine 300 determines if the time since the vehicle is parked exceeds a time threshold, such as thirty minutes and, if not, the parking spot is determined not to be a potential candidate. If the vehicle has been parked for greater than the time threshold of thirty minutes, and the person-to-vehicle communication has been activated, the vehicle is presumed to be departing the current parking spot location as set forth in step 318 which the vehicle is likely to be leaving within two minutes and the potential parking spot can thereby be identified. Accordingly, the vehicle parking spot locator system 20 may advantageously predict when a vehicle is departing from a vehicle parking spot location based upon a person-to-vehicle communication or historical tracking of the vehicle. It should further be appreciated that further predictions of vehicles arriving at or departing from one or more parking spot locations may be determined by the vehicle parking spot locator system 20, according to other embodiments.

FIG. 9 illustrates a method 400 for managing vehicle parking spot locations and providing parking spot location information to a vehicle 10 that includes processing the stored data in a database 36 with a processor 32 to predict which open parking spot is closest to a desired destination and will be available when the vehicle 10 arrives at the desired destination. In the description that follows, variable names are defined as follows
desired_destination(long, lat) is a temporary variable to store GPS coordinates of the place the user wants to walk to, typically the building entrance of interest.
open_spots(i, long, lat, walk_dist, driving_time, my_vehicle_first_flag) is an array of parking spots currently identified as ‘open’ by the algorithm. The array may include an index, GPS coordinates of each spot, walking distance from this spot to the desired_destination, and driving timing from my vehicle to the current spot.
‘my_vehicle(long, lat)’ is a variable to store GPS coordinates of the vehicle 10.
‘other_vehicles(j, long, lat, driving_time_temp, recently parked status) is an array of info on the other vehicles in or approaching the parking lot.
‘best_time’ is a variable for recording the best time for ‘other vehicles’ to arrive at a current open spot

Step 402, START, may include starting the algorithm, for example being launched by an operator of the vehicle. This step may include the algorithm sending a request to the vehicle parking spot locator system 20 which returns several parameters such as ‘parking_facility_code’, ‘parking_facility_map’, ‘open_spots(i, j, k), and/or ‘moving_vehicles(i)’.

Step 404, SHOW MAP, may include showing a ‘parking_facility_map’ on display 12 in the vehicle 10, for example a navigation (GPS) display.

Step 406, REQUEST DESIRED DESTINATION, may include showing on the display 12 a request to a user to touch area on ‘parking_facility_map’ to indicate a desired destination, i.e. where they plan to go after parking.

Step 408, SELECT DESIRED DESTINATION, may include determining an x-y coordinate on the display 12 corresponding to where the user touched the display 12.

Step 410, DETERMINE DESIRED DESTINATION, may include determining or looking up GPS coordinates corresponding to the x-y touch input coordinates and storing those coordinates in the processor 32 or other memory as ‘desired_destination(long, lat)’

Step 412, DETERMINE VEHICLE LOCATION, may include determining the vehicle's present GPS coordinates from, for example, a vehicle navigation system or mobile GPS device, and storing that location or coordinates in ‘my_vehicle( )’.

Step 414, DETERMINE OPEN SPOTS, may include determining one or more available open parking spots by, for example, recalling a one or more locations from the ‘open_spots’ array.

Step 416, DETERMINE WALKING DISTANCE, may include calculating a walking distance or estimating a walking time between current ‘open_spot( )and ‘desired_destination( )’ and storing that distance or time in, for example, the ‘open_spot( ) array. Such a calculation or estimation may be performed using known technology such as Google Maps™.

Step 418, ESTIMATE DRIVING TIME, may include estimating a driving time for the vehicle 10 to arrive at one or more of the locations in the ‘open_spots’ array, and storing that time in ‘open_spot’ array.

Step 420, DETERMINE OTHER VEHICLES, may include designating which of the vehicles listed in the ‘moving_vehicles’ array is likely to be looking for an open parking space near the desired destination. It is recognized that this determination should skip vehicles that were recently parked.

Step 422, ESTIMATE OTHER TIME, may include calculating or estimating a driving time for each of the ‘other_vehicles( )’ to arrive at and possibly occupy one of the presently open parking spaces listed in the ‘open_spot’ array, and storing that others driving time in the ‘other_vehicles( )’ array.

Step 424, REPEAT FOR ALL OTHER VEHICLES, may include returning to step 420 until all of the ‘other vehicles’ have estimated driving times.

Step 426, SEARCH OTHERS DRIVING TIMES, may include searching the ‘other_vehicles’ array for the smallest driving time(temp variable) and set ‘best_time’ to that time. If the vehicle 10 has a driving time equal to the best time, then the preferred parking spot, defined by, for example the shortest walking time, is probably going to be arrived at first by the vehicle 10. If the vehicle 10 has a driving time greater than the best time, then the algorithm may direct the operator toward an open parking space that has a greater walking time so that the open parking space will likely be available or open when the vehicle 10 arrives near the desired destination.

Step 428, DETERMINE PARKING DESTINATION, may include deciding if ‘open_spot (,,, driving_time)’<‘best_time’, and if true, setting ‘open_spot(,,,,, my_vehicle_first_flag)=1 indicating that the vehicle 10 has the shortest driving time to the current closest open parking spot.

Step 430, REPEAT FOR OTHER OPEN SPOTS, may include repeating for up to all of the open parking spots indicated in ‘open_spots’ array until an open parking spot having a high probability of availability is determined. repeating may be by way or returning to step 414.

Step 432, SORT OPEN SPOTS, may include sorting the ‘open_spot( )’ array in accordance with the ‘open_spot(,,, walking_dist,,) value by sorting from the least walking distance to the greatest walking distance.

Step 434, SCAN OPEN SPOTS, may include scanning the ‘open_spot( )’ array from smallest to largest until conditions indicate that ‘open_spot(,,, my_vehicle_first_flag)=1, i.e. the closest spot for which the vehicle 10 is likely to reach before it is occupied by another vehicle.

Step 436, INDICATE ROUTE, may include highlighting the route to the selected parking spot on the display 12 in the vehicle 10,

Step 438, REPORT OPEN SPOT, may include reporting the selected spot to the open parking spot system so that other vehicles 48 may be notified that a particular open parking space has been spoken for.

Step 440, SELECT OPTIONAL SPOT, is an optional step that may include displaying a button on the display 12 to allow an operator of the vehicle 10 to select or request another spot for any reason, for example the optional parking spot is about half way between two nearby desired destinations.

Step 442, WAIT, is an optional step may include waiting for a parking spot status change, for example either because the vehicle 10 or another vehicle 48 has arrived at a selected parking spot, or the driver has requested a new parking spot, or the open parking spot system has reported that the selected open parking spot has been taken in some other way.

Step 444, ARRIVE AT SPOT, may include determining if spot available when the vehicle 10 arrives at parking spot. If yes, then park the vehicle 10, done with algorithm or method 400. If not, go to Step 446

Step 446, SELECT ALTERNATE SPOT, may include selecting a new spot because, for example, a requested change by the operator of the vehicle 10 because the parking spot is too small or crowded by other vehicles, or a new spot needs to be selected because the system learns that the previously open spot has been occupied. This may include returning to Step 412.

Accordingly, the vehicle parking spot locator system 20 advantageously provides for an enhanced parking spot location assist for vehicles so as to help manage the vehicle parking scenario. The vehicle parking spot locator system 20 advantageously utilizes connected vehicles and other data sources to provide for enhanced parking assist particularly in an urban environment.

While this invention has been described in terms of the preferred embodiments thereof, it is not intended to be so limited, but rather only to the extent set forth in the claims that follow.

We claim:

1. A vehicle parking spot locator system comprising:
a database storing data pertaining to vehicle parking spot locations including available parking spot locations;
a communication link for communicating with one or more vehicles, said communication link receiving parking spot location information including information pertaining to the availability of one or more parking spot locations, said communication link further providing a vehicle with parking spot location information to assist in locating an available parking spot location; and
a processor for processing the stored data in the database and generating parking spot location information relevant to the vehicle, wherein the processor is configured to predict which open parking spot is closest to a desired destination and will be available when the vehicle arrives at the desired destination.

2. The system as defined in claim 1, wherein the database is located remote from a vehicle.

3. The system as defined in claim 1, wherein the communication link receives parking spot location information from one or more vehicles.

4. The system as defined in claim 3, wherein the one or more vehicles comprise one or more sensors for sensing availability of one or more parking spot locations, wherein the vehicle inputs the sensed parking spot location data to the database.

5. The system as defined in claim 3, wherein the vehicle comprises a location sensor for providing location of the vehicle, wherein the database may determine whether the vehicle is located in a parking spot location or not.

6. The system as defined claim 3, wherein the vehicle comprises sensors for detecting vehicles and locations adjacent to the vehicle so as to determine whether parking spot locations are available or not.

7. The system as defined in claim 6, wherein the sensors detect availability of parking spot locations as the vehicle is traveling.

8. The system as defined in claim 1, wherein the database further receives inputs from monitored parking spot locations indicating whether or not one or more vehicles are located at the monitored parking spot locations.

9. The system as defined in claim 4, wherein the database receives a signal from a communication device that interacts with a vehicle, such that the interaction may be indicative of the vehicle expected to leave a parking spot location.

10. The system as defined in claim 9, wherein the communication device comprises a vehicle fob, such that activation of the fob is used to predict that the vehicle will soon depart a parking spot location.

11. The system as defined in claim 1, wherein the database further receives driver preferences so as to select available parking spot locations based on the driver's preferences.

12. A method for managing vehicle parking spot locations and providing parking spot location information to one or more vehicles, said method comprising the steps of:
storing data in a database pertaining to vehicle parking spot locations including available parking spot locations;
receiving parking spot location information input via a communication link including information pertaining to availability of parking spot locations;
processing the stored data in the database with a processor to predict which open parking spot is closest to a desired destination and will be available when a vehicle arrives at the desired destination; and
communicating via the communication link with the vehicle to provide the vehicle with parking spot location information to assist in locating a parking spot location.

13. The method as defined in claim 12 further comprising the step of receiving park location information from one or more vehicles via the communication link.

14. The method as defined in claim 12 further comprising the step of receiving a signal from a communication device that interacts with a vehicle, such that the interaction may be indicative of the vehicle expected to leave a parking spot location.

15. The method as defined in claim 12 further comprising the step of processing driver preferences so as to select available parking spot locations based on the driver's preferences.
